(19) United States
(12) Patent Application Publication
(10) Pub. No.: US 2025/0090397 A1
(43) Pub. Date: Mar. 20, 2025

(54) Patient Transport Apparatus Having A Backup Power System

(71) Applicant: Stryker Corporation, Kalamazoo, MI (US)

(72) Inventors: Madhu Sandeep Thota, Portage, MI (US); Anish Paul, Kalamazoo, MI (US); Krishna Sandeep Bhimavarapu, Kalamazoo, MI (US)

(73) Assignee: Stryker Corporation, Kalamazoo, MI (US)

(21) Appl. No.: 18/724,272

(22) PCT Filed: Apr. 20, 2023
(86) PCT No.: PCT/US2023/019195

§ 371 Date: Jun. 26, 2024

Related U.S. Application Data
(60) Provisional application No. 63/332,816, filed on Apr. 20, 2022.

(51) Int. Cl. A61G 7/018; A61G 7/012; A61G 7/015

(52) U.S. Cl. CPC A61G 7/018; A61G 7/012; A61G 7/015; A61G 2203/10

(57) ABSTRACT

A patient transport system including a patient transport apparatus. The patient transport apparatus may include a support structure having a lift assembly having a powered lift actuator to raise and lower the patient transport apparatus. The patient transport apparatus includes a primary user input device for operating the lift assembly when a state of charge of a battery is above a predetermined threshold. The patient transport system may further include a backup system including a backup user input device for operating the lift assembly when the state of charge of the battery is below the predetermined threshold.

### CROSS-REFERENCE TO RELATED APPLICATION

The subject patent application claims priority to and all the benefits of U.S. Provisional Patent Application No. 63/332,816 filed on Apr. 20, 2022, the disclosure of which is hereby incorporated by reference in its entirety.

### BACKGROUND

Patient transport apparatuses, such as hospital beds, stretchers, cots, tables, wheelchairs, chairs, and the like are used to help caregivers facilitate care of patients in a health care setting. Conventional patient transport apparatuses generally include a base, an intermediate frame, and a patient support deck operatively attached to the intermediate frame. Certain patient transport apparatuses may also include one or more powered devices, such as a powered lift assembly with one or more actuators for lifting and lowering the intermediate frame relative to the base.

Power for driving powered devices such as actuators may be provided via an extension cord or tether plugged into a wall outlet. Additionally, some patient transport apparatuses include an on-board battery to supply power to actuators and other powered devices when the cord/tether is not plugged into a wall outlet.

While conventional patient transport apparatuses have generally performed well for their intended purpose, there remains a need in the art for a patient transport apparatus that affords opportunities for enhanced usability in a number of different operating conditions.

### SUMMARY

One general aspect of the present disclosure includes a patient transport system for supporting a patient. The patient transport system includes a patient transport apparatus and a backup system. The patient transport apparatus includes a support structure including a base, an intermediate frame having a patient support deck, and a lift assembly arranged between the base and the intermediate frame. The lift assembly includes an electric actuator configured to raise and lower the intermediate frame relative to the base The patient transport apparatus also includes a primary battery for providing power to the patient transport apparatus, and a primary user input device coupled to the support structure and arranged for user engagement to operate the lift assembly.

The patient transport apparatus further includes a patient transport apparatus controller disposed in electrical communication with at least the lift assembly, the primary battery, and the primary user input device. The patient transport apparatus controller is operable between a suspended mode, and an operating mode to drive the electric actuator of the lift assembly with power from the primary battery in response to user engagement with the primary user input device when a charge state of the primary battery is above a predetermined charge threshold.

The patient transport system also includes a backup system for operating the lift assembly during operation of the patient transport apparatus controller in the suspended mode. The backup system includes a backup battery operatively attached to the support structure for providing power to the electric actuator, and a backup user input device in electrical communication with the backup battery and the electric actuator. The backup user input device arranged for user engagement to operate the lift assembly during operation of the patient transport apparatus controller in the suspended mode.

Another general aspect of the present disclosure includes a patient transport apparatus for supporting a patient. The patient transport apparatus includes a support structure including a base, an intermediate frame having a patient support deck, and a lift assembly arranged between the base and the intermediate frame. The lift assembly includes an electric actuator configured to raise and lower the intermediate frame relative to the base. The patient transport apparatus also includes a battery for providing power to the patient transport apparatus. The patient transport apparatus further includes a primary user input device coupled to the support structure and arranged for user engagement to operate the lift assembly. The patient transport apparatus also further includes a patient transport apparatus controller disposed in electrical communication with the lift assembly, the battery, and the primary user input device. The patient transport apparatus controller is configured to operate the lift assembly between a suspended mode and an operating mode to drive the electric actuator of the lift assembly with power from the battery in response to user engagement with the primary user input device when a charge state of the battery is above a predetermined charge threshold.

The patient transport apparatus also includes a backup system for operating the lift assembly during operation of the patient transport apparatus in the suspended mode, the backup system including a backup user input device coupled to the support structure and in electrical communication with the battery and the electric actuator, the backup user input device arranged for user engagement to operate the lift assembly when the patient transport apparatus controller is in the suspended mode.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a schematic side view of a patient transport apparatus having a base, an intermediate frame supporting a patient transport surface, a lift assembly, and a backup system for providing power to the lift assembly, with the lift assembly being in a raised position.

FIG. 2A is a schematic side view of a patient transport apparatus of FIG. 1, with the lift assembly being in a lowered position, and shown having a fowler section arranged in a first section position.

FIG. 2B is a schematic side view of a patient transport apparatus of FIG. 1, with the lift assembly being in a lowered position, and shown having a fowler section arranged a second section position.

FIG. 3 is a schematic side view of a patient transport apparatus of FIG. 1, with a head end actuator of the lift assembly being in a raised position and a foot end actuator of the lift assembly being in a lowered position.

FIG. 4 is a schematic side view of a patient transport apparatus of FIG. 1, with a head end actuator of the lift assembly being in a lowered position and a foot end actuator of the lift assembly being in a raised position.

FIG. 5 is a schematic representation of a first configuration of a primary input control.

FIG. 6 is a schematic representation of a second configuration of a primary input control.

FIG. 7 is a schematic representation of a first configuration of a patient transport system including a patient transport apparatus and a backup system.

FIG. 8 is a schematic representation of a second configuration of a patient transport system including a patient transport apparatus and a backup system.

FIG. 9 is a schematic representation of a third configuration of a patient transport system including a patient transport apparatus and a backup system.

FIGS. 10A and 10B are schematic representations of a fourth configuration of a patient transport system including a patient transport apparatus and a backup system.

FIGS. 11A and 11B illustrate one configuration for operatively attaching a backup user input and a backup battery to a patient transport apparatus.

FIGS. 12A and 13A illustrate one configuration of operating a backup system including a first backup input control and a second backup input control.

FIG. 12B and 13B are a schematic representation of a lift assembly of a patient transport apparatus moving an intermediate frame relative to a base in response to simultaneous actuation of the first backup input control and the second backup input control of FIGS. 12A and 13A.

### DETAILED DESCRIPTION

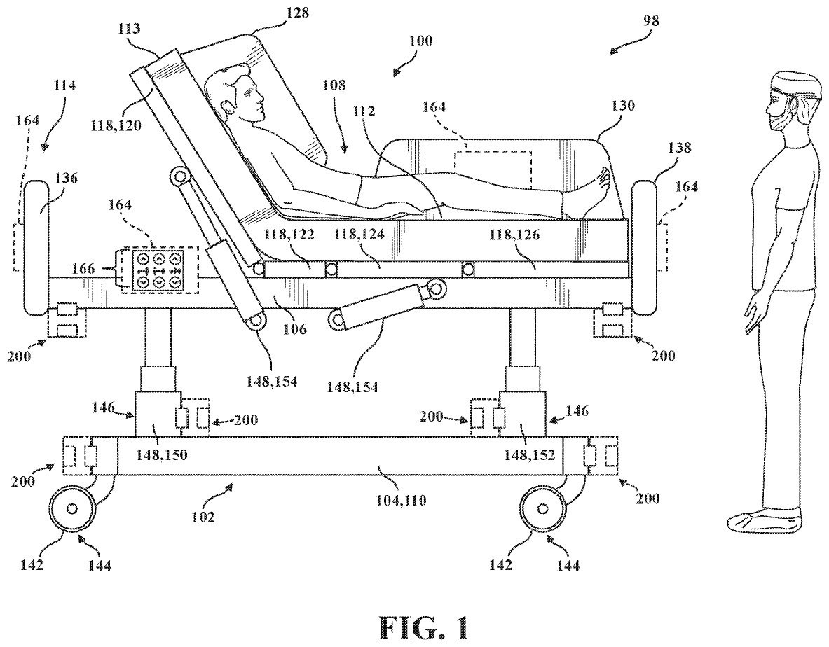

Referring to FIGS. 1-4, a schematic representation of an exemplary patient transport apparatus 100 is shown for supporting a patient in a health care setting. The patient transport apparatus 100 illustrated in FIG. 1 comprises a stretcher. In other versions, however, the patient transport apparatus 100 may comprise a hospital bed, cot, table, wheelchair, or similar apparatus utilized in the care of a patient.

A support structure 102 provides support for the patient. The support structure 102 illustrated in FIG. 1 comprises a base 104 movable about a floor surface F, and an intermediate frame 106 having a patient support deck 108. The base 104 may comprise a base frame 110. The intermediate frame 106 and the patient support deck 108 are spaced above the base 104 in FIGS. 1-4. The patient support deck 108 provides a patient support surface 112 upon which the patient is supported.

A mattress 113 may be disposed on the patient support deck 108 during use. The mattress 113 comprises a secondary patient support surface upon which the patient is supported. The base 104, intermediate frame 106, patient support deck 108, and patient support surfaces 112 each have a head-end 114 and a foot-end 116 corresponding to designated placement of the patient's head and feet on the patient transport apparatus 100. The construction of the support structure 102 may take on any suitable design and is not limited to that specifically set forth above. In addition, the mattress 113 may be omitted in certain versions, such that the patient rests directly on the patient support surface 112.

As will be discussed in greater detail below, the patient support deck 108 may include at least one deck section 118 arranged for movement relative to the intermediate frame 106 to support the patient in different positions, orientations, and the like. The deck sections 118 of the patient support deck 108 provide the patient support surface 112 upon which the patient is supported. More specifically, in the representative version of the patient transport apparatus 100 illustrated in FIGS. 1-4, the patient support deck 108 has four deck sections 118, which cooperate to define the patient support surface 112: a fowler section 120 (or back section), a seat section 122, a leg section 124, and a foot section 126. Here, the seat section 122 is fixed to the intermediate frame 106 and is not arranged for movement relative thereto. However, it will be appreciated that the seat section 122 could be movable relative to other deck sections 118 in some versions. Conversely, the fowler section 120 and the leg section 124 are arranged for movement relative to each other and to the intermediate frame 106, as described in greater detail below, and the foot section 126 is arranged to move partially concurrently with the leg section 124. Other configurations and arrangements are contemplated.

Side rails may be coupled to the intermediate frame 106 and are thereby supported by the base 104. A first side rail 128 may be positioned at a right head end of the intermediate frame 106. A second side rail 130 may be positioned at a right foot end of the intermediate frame 106. A third side rail (not shown) may be positioned at a left head end of the intermediate frame 106. A fourth side rail (not shown) may be positioned at a left foot end of the intermediate frame 106. Where the patient transport apparatus 100 is a stretcher or a cot, there may be fewer side rails. The side rails are movable to a raised position in which they block ingress and egress into and out of the patient transport apparatus 100, one or more intermediate positions, and a lowered position in which they are not an obstacle to such ingress and egress. In still other configurations, the patient transport apparatus 100 may not include any side rails. The Applicant has described versions of patient transport apparatuses having side rails equipped with actuators for “motorized” movement in United States Patent Application Publication No. US 2017/0172829 A1, the disclosure of which is hereby incorporated by reference in its entirety. Other configurations are contemplated. The side rails could be of any suitable type, arrangement, or configuration sufficient to selectively limit patient ingress/egress from the patient transport apparatus 100. Similarly, it will be appreciated that side rails may be attached to any suitable component or structure of the patient transport apparatus 100. Furthermore, in certain versions the side rails are coupled to one of the deck sections 118 for concurrent movement.

A headboard 136 and a footboard 138 may be coupled to the intermediate frame 106. In other versions, when the headboard 136 and footboard 138 are included, the headboard 136 and footboard 138 may be coupled to other locations on the patient transport apparatus 100, such as the base 104. In still other versions, the patient transport apparatus 100 may not include the headboard 136 and/or the footboard 138.

One or more grips (i.e., “handles”; not shown) may be integrated into the side rails, the headboard 136, and the footboard 138. In some versions, grips formed in the side rails are arranged to help facilitate patient egress from the patient transport apparatus 100. It will be appreciated that the grips formed in the side rails, as well as grips formed in the headboard 136 and/or the footboard 138, can also be used by a caregiver to facilitate movement of the patient transport apparatus 100 over floor surfaces. Additional grips may be integrated into other components of the patient transport apparatus 100, such as the intermediate frame 106. The grips are shaped so as to be grasped by the patient or the caregiver. It will be appreciated that the grips could be integrated with or operatively attached to any suitable portion of the patient transport apparatus 100 or may be omitted from certain parts of the patient transport apparatus 100 in certain versions.

In addition to the headboard 136 the patient transport apparatus may further comprise user input handles (not shown). The user input handles are operable by the caregiver to control various functions of the patient transport apparatus such as powered drive wheels, steering, braking, and the like. The user input handles may further comprise buttons for selecting between different operation modes or other user configurable options that change operating parameters of the patient transport apparatus 100.

Wheels 142 are coupled to the base 104 to facilitate transportation over floor surfaces F. The wheels 142 are arranged in each of four quadrants of the base 104 adjacent to corners of the base 104. In the version shown in FIGS. 1-4, the wheels 142 are caster wheels able to rotate and swivel relative to the support structure 102 during transport. Here, each of the wheels 142 forms part of a caster assembly 144 that is mounted to the base 104. It should be understood that various configurations of the caster assemblies 144 are contemplated. In addition, in some versions, the wheels 142 are not caster wheels and may be non-steerable, steerable, non-powered, powered, or combinations thereof. Additional wheels are also contemplated. For example, the patient transport apparatus 100 may comprise four non-powered, non-steerable wheels, along with one or more powered wheels. In some cases, the patient transport apparatus 100 may not include any wheels. In other versions, one or more auxiliary wheels (powered or non-powered), which are optionally movable between stowed positions and deployed positions, may be coupled to the support structure 102. In some cases, when auxiliary wheels are located between caster assemblies 144 and contact the floor surface in the deployed position, they cause two of the caster assemblies 144 to be lifted off the floor surface, thereby shortening a wheelbase of the patient transport apparatus 100. A fifth wheel may also be arranged substantially in a center of the base 104.

The patient transport apparatus 100 further comprises a lift assembly, generally indicated at 146, which operates to raise and lower the intermediate frame 106 relative to the base 104 which, in turn, moves the patient support deck 108 relative to the base 104 between a plurality of lift configurations, including a lowered lift configuration where the patient support deck 108 is positioned adjacent to the base 104, a raised lift configuration where the patient support deck 108 is elevated vertically above the base 104, or any desired vertical position therebetween. To this end, the lift assembly 146 may comprise one or more powered actuators 148 (i.e., electric actuator 148), such as a head-end lift actuator 150 and a foot-end lift actuator 152, which are each operatively attached between the intermediate frame 106 and the base 104 and arranged to facilitate movement of the patient support surface 112 with respect to the base 104. For example, the head end actuator 150 may be arranged to raise and lower the intermediate frame 106 relative to the base 104 adjacent to the head end 114, and the foot end actuator 152 may be arranged to raise and lower the intermediate frame 106 relative to the base 104 adjacent to the foot end 116.

The head-end and foot-end actuators 150,152 may be realized as linear actuators, rotary actuators, or other types of actuators, and are electrically powered and operated. It is contemplated that, in some versions, different arrangements of actuators may be employed, such as with rotary actuators coupled to the base 104 and to the intermediate frame 106 with a linkage extending therebetween. Furthermore, in some versions, one or more of the actuators 148 may be realized as linear actuators, rotary actuators, or other configurations of actuators configured to generate force, torque, and the like, such as via one or more electric motors, which may be coupled to geartrains, linkages, and the like to effect movement of various components of the patient transport apparatus 100, and/or which may be coupled to pumps (e.g., a hydraulic pump) disposed in fluid communication with fluid-driven actuators (e.g., hydraulic linear or rotational actuators). Other configurations are contemplated. The construction of the lift assembly 146, the head-end actuator 150, and/or the foot-end actuator 152 may take on any known or conventional design and is not limited to that specifically illustrated. By way of non-limiting example, the lift assembly 146 could be arranged with the head-end and foot-end actuators 150, 152 between the base 104 and the intermediate frame 106 in a column configuration to facilitate vertical movement of the patient support deck 108. Each of the one or more actuators 148 is operable in a first direction to raise the intermediate frame 106 relative to the base 104, and in a second direction to lower the intermediate frame 106 relative to the base 104.

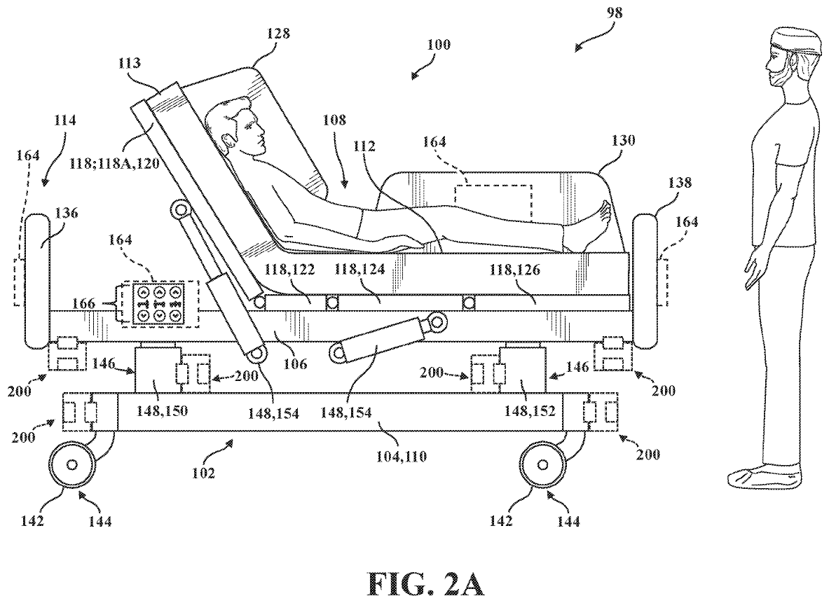

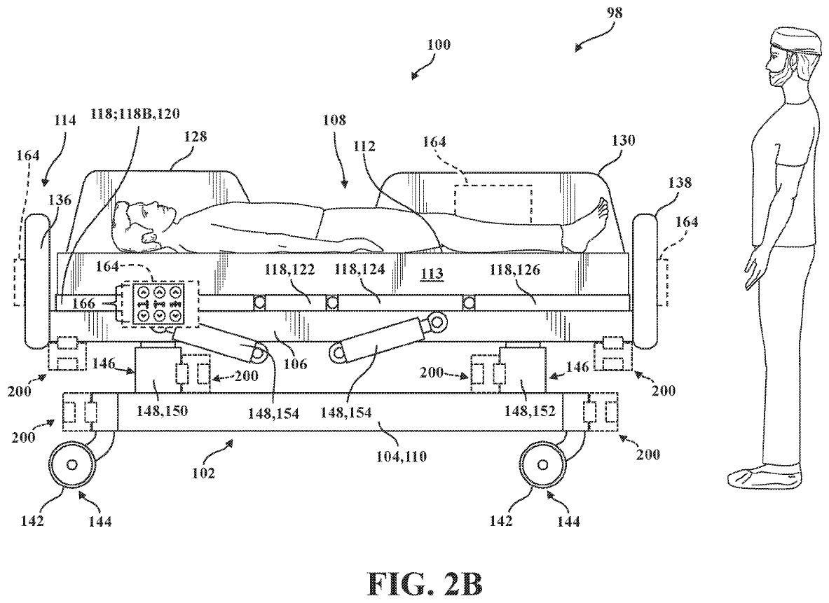

As noted above, the patient support deck 108 is operatively attached to the intermediate frame 106, and one or more of the deck sections 118 may be arranged for movement between a first section position 118A (see FIG. 2A) and a second section position 118B (see FIG. 2B), and one or more intermediate section positions therebetween. To this end, one or more powered actuators 148 realized as deck actuators 154 may be interposed between the deck section 118 and the intermediate frame 106 to move the deck section 118 between the first section position 118A (see FIG. 2A), the second section position 118B (see FIG. 2B), and any other suitable section position. In the representative version illustrated herein, the deck actuator 154 is realized as a linear actuator disposed in force-translating relationship between the deck section 118 and the intermediate frame 106. More specifically, one deck actuator 154 is provided between the intermediate frame 106 and the fowler section 120, and another deck actuator 154 is provided between the intermediate frame 106 and the leg section 124, and each of the deck actuators 154 is arranged for independent movement to position the respective deck sections 118 to adjust the shape of the patient support surface 112 between a plurality of patient support configurations (for example, a flat configuration, a raised fowler configuration, a seated configuration, etc.).

Those having ordinary skill in the art will appreciate that the patient transport apparatus 100 could employ any suitable number of deck actuators 154, of any suitable type or configuration sufficient to effect selective movement of the deck section 118 relative to the support structure 102. By way of non-limiting example, the deck actuator 154 could be realized with one or more linear actuators and/or one or more rotary actuators controlled or driven in any suitable way. Moreover, the deck actuator 154 could be mounted, secured, coupled, or otherwise operatively attached to the intermediate frame 106 and to the deck section 118, either directly or indirectly, in any suitable way. In addition, one or more of the deck actuators 154 could be omitted for certain applications.

Each of the one or more actuators 148 includes an actuator input 190 (also referred to as lift assembly input 190 in subsequent descriptions of the lift assembly 156 below) defined to receive power to operate the one or more actuators 148. For example, the head end actuator 150 may define a head end actuator input 212A for receiving power to operate the head end actuator 150. Similarly, the foot end actuator 152 may define a foot end actuator input 212B for receiving power to operate the foot end actuator 152. While the deck actuators 154 or other actuators 148 likewise include respective inputs for receiving power, subsequent description of the arrangement for providing power to the one or more actuators 148 will be made with reference to the head end actuator 150 and the foot end actuator 152 for illustrative purposes.

As mentioned above, the patient transport apparatus 100 may comprise powered drive wheels in addition to a powered lift assembly 146. In some implementations of the patient transport apparatus 100, these systems of the patient transport apparatus 100 may be electrically powered and controlled using energy stored in a battery 160 (in some configurations, referred to as a “primary battery”). The battery 160 may be supported on, or in, the base 104, the intermediate frame 106, or other suitable locations about the patient transport apparatus 100, and is electrically coupled to the powered drive wheels, powered lift actuators, and a patient transport apparatus controller 158 to provide these and other components with electrical power. The battery 160 may include one or more cells (not shown) disposed in a battery housing, and one or more battery outputs 162 in communication with the cells and supported by the battery housing for engaging corresponding inputs on the patient transport apparatus 100, as will be discussed in further detail below. It will be appreciated that the representative versions of the battery 160 depicted throughout the drawings are shown schematically for illustrative purposes, and that various configurations, types, and arrangements of batteries 160 are contemplated by the present disclosure.

The battery 160 may comprise one cell or a plurality of cells electrically coupled to one another in order to increase storage capacity or voltage of the battery 160. The battery 160 may utilize cells having a variety of compositions. For example, the cells may be Lithium-ion type, however other types of battery such Nickel-Cadmium, Nickel-metal hydride, or Lithium polymer are also contemplated. To this end, the battery 160 may be configured to provide a suitable voltage to the battery output(s) 162 by way of different arrangement of the cells (e.g. series, parallel, series-parallel, etc.). For example, the battery 160 may provide 3.7V, 5V, 6V, 12V, 18V, 36V, 40V, 60V, etc., and combinations thereof. The battery 160 may further be configured for recharging by way of a charging assembly (not shown) connected to a mains power supply or another external battery pack (not shown). The battery 160 may comprise an electrical port (not shown) in addition to the battery output that allows the battery 160 to receive power from the charging assembly. While the port may assume various configurations, in one exemplary version, the electrical port comprises a USB port. In another version, the battery 160 may be configured to be wirelessly recharged via an inductive charging circuit.

In some versions, the battery 160 may be configured to be removed from and attached to the patient transport apparatus 100 by a caregiver in order to facilitate untethered (e.g., disconnected from mains power) operation of the patient transport apparatus 100. During operation, a discharged battery 160 may be removed by a caregiver and replaced with a charged battery 160. Said differently, because a discharged battery 160 can quickly and easily be replaced with a charged battery 160, lower capacity and smaller volume batteries may be utilized without negatively impacting the usability of the patient transport apparatus 100. However, in other versions the battery 160 may not be configured to be removed from the patient transport apparatus 100. Similarly, in versions which employ multiple batteries 160, one or more batteries 160 may be not configured to be removed from the patient transport apparatus 100, while other batteries 160 may be configured and arranged for replacement by a caregiver.

The patient transport apparatus 100 further includes a primary user input device 164. The primary user input device 164 may be coupled to or otherwise arranged at any suitable location on the support structure 102. For example, in some configurations, the primary user input device 164 is coupled to the intermediate frame 106 for concurrent movement with the intermediate frame 106 relative to the base 104. The primary user input device 164 may be coupled directly to the intermediate frame 106, or may be indirectly coupled to the intermediate frame 106, such as to the footboard 138 and/or to one of the side rails 130 which move concurrently with the intermediate frame 106. FIGS. 1-4 employ phantom lines to illustrate various exemplary and non-limiting locations for coupling the primary user input device 164 to the support structure 102, including coupling the primary user input device 164 to the intermediate frame 106, the headboard 136, the footboard 138, and/or the side rails 130. Other locations for coupling the primary user input device 164 to the support structure 102 are contemplated such as, but not limited to, the base 104.

The primary user input device 164 is arranged for user engagement to operate the various functions of the patient transport apparatus 100 such as, but not limited to, operating the lift assembly 146, adjusting the deck actuators 154 or other powered devices, and the like. Other potential functions of the patient transport apparatus 100 that the primary user input device 164 may be configured to operate include, but are not limited to, various alarm/indicator systems of the patient transport apparatus 100, various lighting systems associated with the patient transport apparatus 100, various climate control systems associated with the patient transport apparatus 100, and/or various patient therapy or treatment systems associated with the patient transport apparatus 100. Other configurations are contemplated.

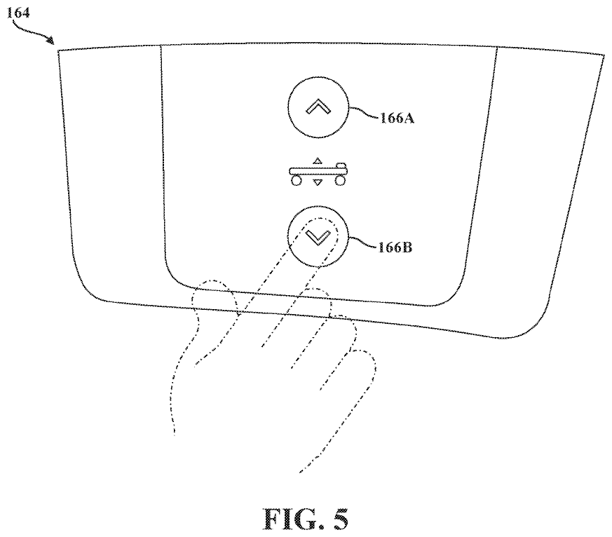

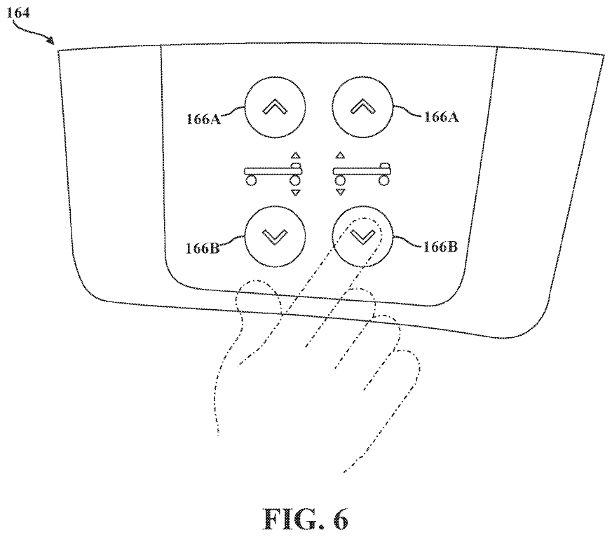

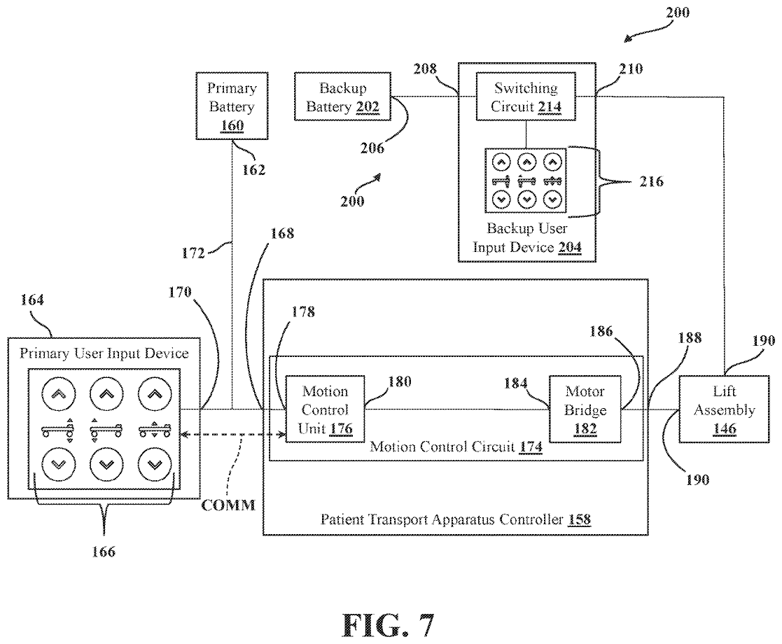

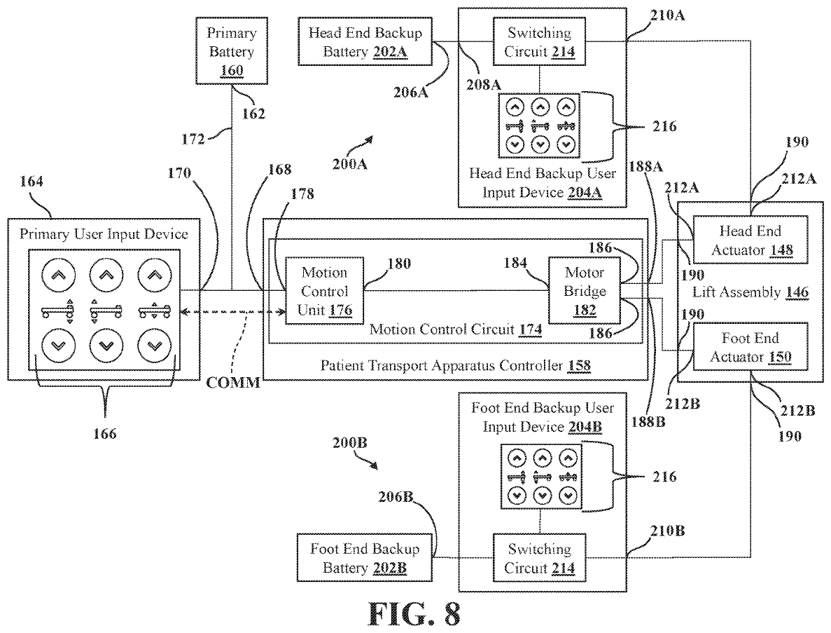

The primary user input device 164 includes one or more primary input controls 166 arranged for user engagement to operate functions of the patient transport apparatus 100 such as, but not limited to, operating the lift assembly 146. For example, FIG. 5 shows one exemplary configuration of a portion of the primary user input device 164 including the one or more input controls 166 for operating the lift assembly 146. It will be appreciated that the primary user input device 164 could include a number of different other input controls for operating other powered devices (not shown). In the illustrated configuration, the primary user input device 164 includes a first primary input control 166A and a second primary input control 166B. The primary input controls 166 may be realized as elements arranged for user engagement (e.g., a touch screen or other graphic user interface, or as physical controls such as buttons, levers, switches, etc.) to operate various functionalities of the patient transport apparatus 100.

As will be discussed in further detail below, the primary input controls 166 are in electrical communication with the patient transport apparatus controller 158 to provide input signals to the patient transport apparatus controller 158 to effectuate the operation of the various functionalities of the patient transport apparatus 100. For example, in the configuration shown in FIG. 5, the first primary input control 166A is in communication with the patient transport apparatus controller 158 to provide an input signal to the patient transport apparatus controller 158. In response to receiving the input signal from the first primary input control 166A, the patient transport apparatus controller 158 is configured to provide power from the battery 160 to the lift assembly 146 (particularly, the one or more actuators 148) to raise the intermediate frame 106 relative to the base 104. Similarly, the second primary input control 166B is in communication with the patient transport apparatus controller 158 to provide an input signal to the patient transport apparatus controller 158. In response to receiving the input signal from the second primary input control 166B, the patient transport apparatus controller 158 is configured to provide power from the battery 160 to the lift assembly 146 (particularly, the head end actuator 150 and the foot end actuator 152) to lower the intermediate frame 106 relative to the base 104.

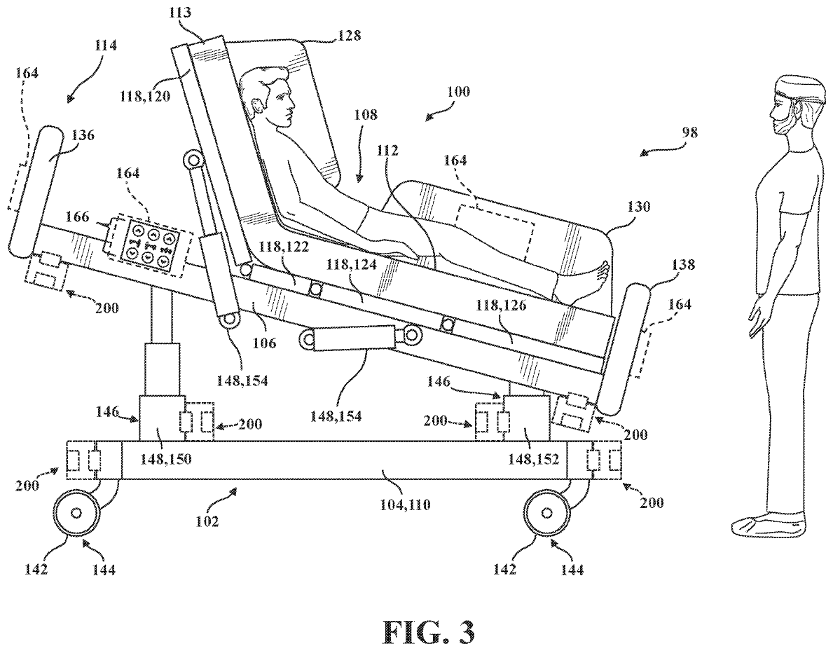

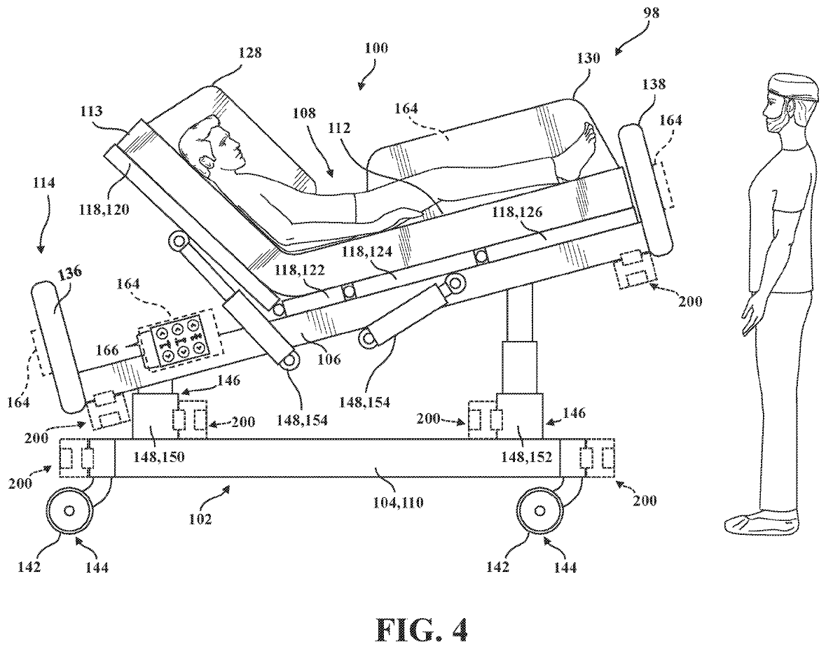

It should be appreciated that the primary user input device 164 can include any number of primary input controls 166 for operating the lift assembly 146. For example, FIG. 6 shows another configuration of the primary user input device 164. In this configuration, the primary user input device 164 includes four primary input controls 166 to allow the head end actuator 150 and the foot end actuator 152 to be operated independently, as illustrated by FIGS. 3 and 4, such as to place the patient support deck 108 in a Trendelenburg or reverse Trendelenburg configuration. Other configurations of the primary user input device may be realized with any suitable number of primary input controls 166 to provide input signals to the patient transport apparatus controller 158 to operate the various functionalities of the patient transport apparatus 100.

In some versions, the patient transport apparatus 100 and a backup system 200 (discussed in further detail below) define a patient transport system 98 for operating the lift assembly 146 or other powered devices of the patient transport apparatus 100 when a state of charge of the battery 160 is below a predetermined threshold. Referring to FIGS. 7-10B, which show schematic representations of a number of configurations of a patient transport system 98 of the present disclosure, the patient transport apparatus controller 158 is disposed in electrical communication with the lift assembly 146, the primary battery 160, and the primary user input device 164. While the patient transport apparatus controller 158 may be in electrical communication with additional subsystems of the patient transport apparatus 100, additional subsystems have been omitted from FIGS. 7-10B for illustrative purposes to schematically depict the interconnection of the patient transport apparatus 100 and the backup system 200.

Referring to FIGS. 7-10B, the battery output 162 of the battery 160 is in electrical communication with a controller power input 168 of the patient transport apparatus controller 158 and a primary user input device power input 170 of the primary user input device 164 across a primary power input circuit 172 to provide power from the battery 160 to the primary user input device 164 and the patient transport apparatus controller 158. However, other circuit configurations for providing power from the battery 160 to the patient transport apparatus controller 158 and the primary user input device 164 are contemplated.

With continued reference to FIGS. 7-10B, the patient transport apparatus controller 158 may include a motion control circuit 174 for operating the lift assembly 146 that is interposed between the battery 160 and the lift assembly 146. The motion control circuit 174 includes a motion control unit 176. The motion control unit 176 may be configured to receive input signals from the primary user input device 164 over a communication circuit COMM. Based on the input signals generated from user engagement with the primary user input device 164 and provided to the motion control unit 176, the motion control unit 176 is configured to provide power to the lift assembly 146 to operate the lift assembly 146. The motion control unit 176 includes a motion control unit input 178 and a motion control unit output 180. The motion control unit input 178 is in electrical communication with the controller power input 168 such that the battery 160 provides power to the motion control unit 176. The motion control circuit 174 also includes a motor bridge 182 for controlling power received from the motion control unit output 180 to move the lift assembly 146 in a desired direction. More particularly, the motor bridge 182 includes a motor bridge input 184 and a motor bridge output 186. The motor bridge input 184 is in electrical communication with the motion control unit output 180 to receive the power from the battery 160 to operate the lift assembly 146. The motor bridge output 186 is in communication with a lift assembly output 188 defined by the motion control circuit 174 of the patient transport apparatus controller 158 to provide power to the lift assembly 146. More particularly, the lift assembly output 188 is in communication with a lift assembly input 190 defined by the lift assembly 146 to provide power to the one or more actuators 148 to operate the one or more actuators 148.

The patient transport apparatus controller 158 may be operable between an operating mode and a suspended mode. In the operating mode, the patient transport apparatus controller 158 is configured to drive the lift assembly 146 with power from the battery 160 in response to user engagement with the primary user input device 164 when a charge state of the battery 160 is above a predetermined charge threshold. Additionally, in the operating mode, the patient transport apparatus controller 158 may be configured to operate other functionalities of the patient transport apparatus 100. In the suspended mode, when the state of charge of the battery 160 is below the predetermined threshold, the patient transport apparatus controller 158 is inhibited from driving the lift assembly 146 with power from the battery 160 in response to user engagement with the primary user input device 164. Additionally, in the suspended mode, the patient transport apparatus controller 158 may be configured to inhibit operation of other functionalities of the patient transport apparatus 100. In some configurations, the predetermined threshold may be any state of charge level where it is no longer suitable to operate the functionalities of the patient transport apparatus 100, such as 0% or less than 5% state of charge. In other configurations, the predetermined threshold may be a state of charge level sufficient to provide reserve power to the functionalities of the patient transport apparatus 100, such as the lift assembly 146, for emergency situations. The state of charge level sufficient to provide reserve power may be a certain percentage of state of charge, such as, but not limited to, 10%, 15%, or 20%, or defined as a state of charge to permit a predetermined number of articulations of the one or more actuators 148 reserved for emergency situations. In the suspended mode, the backup system 200 (described in further detail below) is used for operating the lift assembly 146 during operation of the patient transport apparatus controller 158 in the suspended mode, instead of operating the lift assembly 146 using the primary user input device 164, as in the operating mode.

In some configurations, such as shown in FIGS. 7 and 8, the backup system 200 includes at least one backup battery 202, separate from the primary battery 160, for providing power to the lift assembly 146 during operation of the patient transport apparatus controller 158 in the suspended mode. As will be appreciated from the subsequent description below, “primary” and “backup” are non-limiting terms utilized herein to differentiate between two batteries 160, 202, and other terms (e.g., “first” and “second”) could be used in place of the terms “primary” and “backup” in some versions. The backup system 200 shown in FIGS. 7 and 8 includes at least one separate backup battery 202 for powering the lift assembly 146 even in the event that the state of charge of the primary battery 160 is insufficient to power articulations of the lift assembly 146 (e.g., 0% state of charge or another insufficient state of charge). The at least one backup battery 202 may be operatively attached to the support structure as described in further detail below, and is disposed in electrical communication with the lift assembly 146 for providing power to the lift assembly 146. In some versions, the backup battery 202 is configured to be charged by at least one of the primary battery 160 or an AC mains power supply (not shown). Additionally, the backup system 200 may further include an alarm configured to generate an alert when a state of charge of the backup battery 202 is below an operable threshold. Alternatively, or additionally, the backup system 200 may further include a visual indicator configured to provide visual indication when a state of charge of the backup battery 202 is below an operable threshold.

The backup system 200 shown in FIGS. 7 and 8 also includes at least one backup user input device 204 arranged for user engagement to operate the lift assembly 146 during operation of the patient transport apparatus controller 158 in the suspended mode. The at least one backup user input device 204 is interposed in electrical communication between the at least one backup battery 202 and the lift assembly input 190.

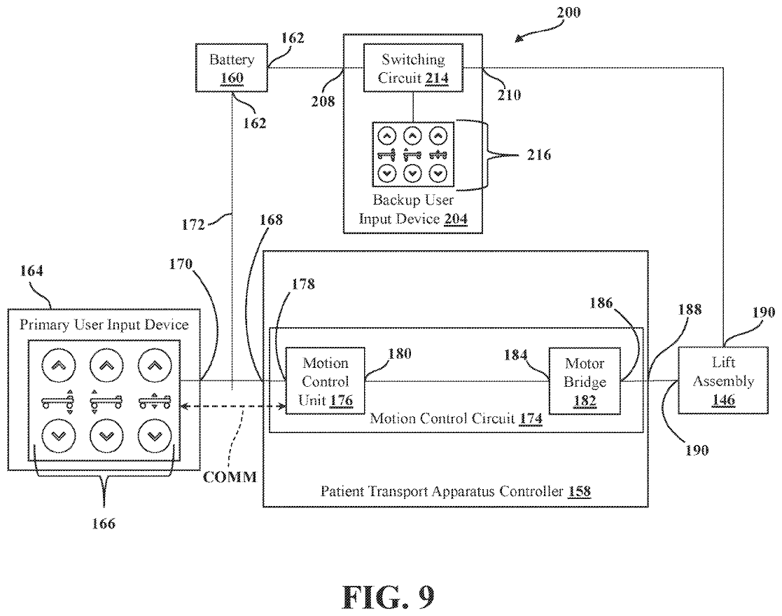

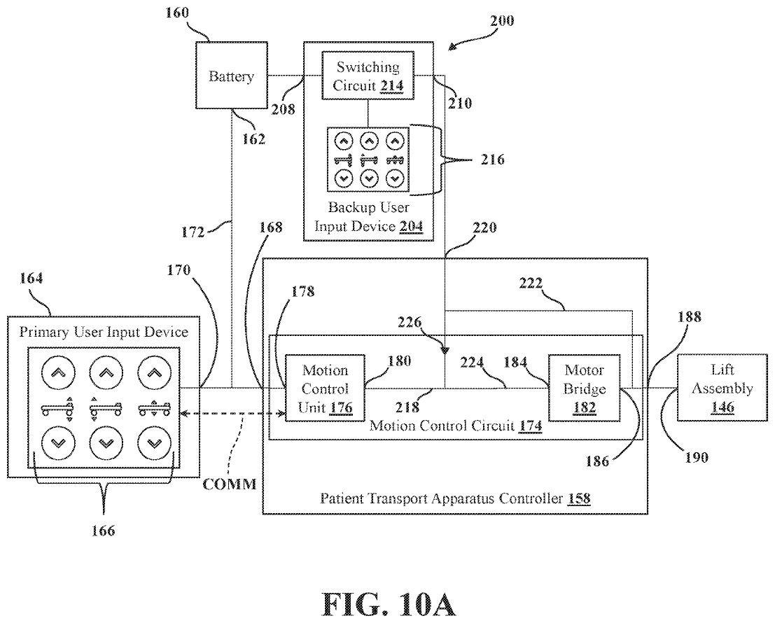

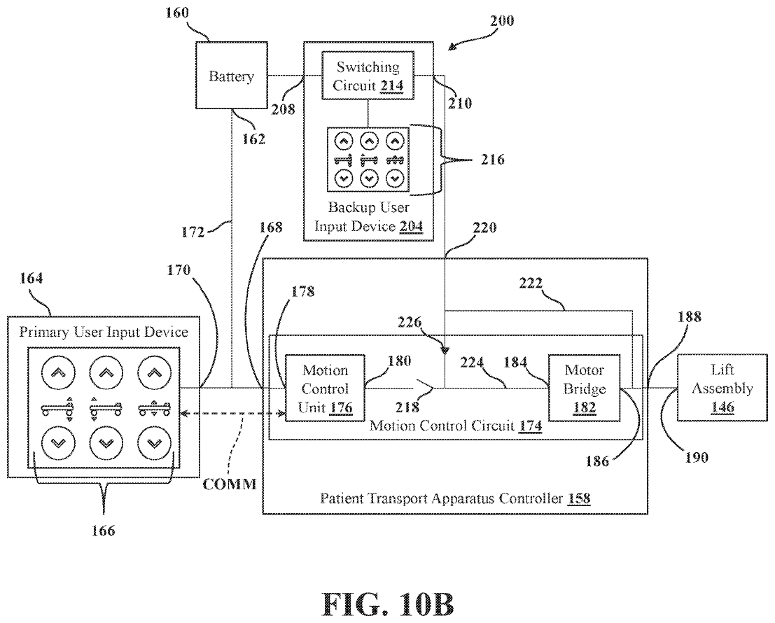

FIGS. 9 and 10A-10B show other configurations of the backup system 200 for operating the lift assembly 146 during operation of the patient transport apparatus controller 158 in the suspended mode that do not include a separate backup battery 202. Here, the backup user input device 204 is interposed in electrical communication between the battery 160 and the lift assembly input 190 for providing power to the lift assembly 146 during operation of the patient transport apparatus controller 158 in the suspended mode. Put differently, the backup system 200 shown in FIGS. 9 and 10A-10B is configured to power the lift assembly 146 when the state of charge of the battery 160 is below the predetermined threshold but has a state of charge level sufficient to provide reserve power to power the lift assembly 146, as described above. Like the configurations shown in FIGS. 7 and 8, the backup user input device 204 shown in FIGS. 9 and 10A-10B is arranged for user engagement to operate the lift assembly 146 during operation of the patient transport apparatus controller 158 in the suspended mode.

Referring back to FIG. 7, the backup battery 202 includes a backup battery output 206. The backup user input device 204 includes a backup user input device input 208 that is in electrical communication with the backup battery output 206 to provide power to the backup user input device 204. The backup user input device 204 also includes a backup user input device output 210 that is in electrical communication with the lift assembly input 190 to provide power to operate the lift assembly 146 during operation of the patient transport apparatus controller 158 in the suspended mode.

As best shown in FIG. 8, in some configurations, the lift assembly output 188 of the patient transport apparatus controller 158 may be further defined as a head end lift assembly output 188A disposed in electrical communication with the head end actuator input 212A defined by the head end actuator 150 to provide power to the head end actuator 150, and the patient transport apparatus controller 158 further defines a foot end lift assembly output 188B disposed in electrical communication with a foot end actuator input 212B defined by the foot end actuator 152 to provide power to the foot end actuator 152. Although not shown, similar configurations of electrical communication between the lift assembly input and the inputs of the one or more actuators 148 are contemplated for the versions shown in FIGS. 7, 9, and 10A-10B.

In other configurations, such as shown in FIG. 8, the backup system 200 may include a head end backup system 200A that includes a head end backup battery 202A and a head end backup user input device 204A to operate the head end actuator 150 using power from the head end backup battery 202A. Additionally, the backup system 200 may include a foot end backup system 200B that includes a foot end backup battery 202B and a foot end backup user input device 206B to operate the foot end actuator 152 using power from the foot end backup battery 202B.

In the configuration shown in FIG. 8, the head end backup system 200A may be disposed in electrical communication with the head end actuator input 212A for operating the head end actuator 150 with power from the head end battery 202A in response to user engagement with the head end backup user input device 204A. Similar to the configuration of FIG. 7, the head end backup battery 202A includes a head end backup battery output 206A. The head end backup user input device 204A includes a head end backup user input device input 208A that is in electrical communication with the head end backup battery 202A to provide power to the head end backup user input device 204A. The head end backup user input device 204A also includes a head end backup user input device output 210A that is in electrical communication with the head end actuator input 212A to provide power to operate the head end actuator 150 during operation of the patient transport apparatus controller 158 in the suspended mode.

With continued reference to FIG. 8, similarly, the foot end backup system 200B may be disposed in electrical communication with the foot end actuator input 212B for operating the foot end actuator 152 with power from the foot end battery 202B in response to user engagement with the foot end backup user input device 204B. Also similar to the configuration of FIG. 7, the foot end backup battery 202B includes a foot end backup battery output 208B. The foot end backup user input device 204B includes a foot end backup user input device input 206B that is in electrical communication with the foot end backup battery 202B to provide power to the foot end backup user input device 204B. The foot end backup user input device 204B also includes a foot end backup user input device output 208B that is in electrical communication with the foot end actuator input 212B to provide power to operate the foot end actuator 152 during operation of the patient transport apparatus controller 158 in the suspended mode.

In some configurations, such as shown in FIGS. 7 and 8, the backup user input devices 204, 204A, 204B may be each configured for user-selected operation between an interrupt state and a drive state. In the configuration of FIG. 7, the interrupt state is defined by interrupted electrical communication between the backup battery 202 and the lift assembly input 190, while the drive state is defined by electrical communication between the backup battery 202 and the lift assembly input 190. In the configuration of FIG. 8, for the head end user input device 204A, the interrupt state is defined by interrupted electrical communication between the head end backup battery 202A and the head end actuator input 212A. Similarly, for the foot end user input device 204B, the interrupt state is defined by interrupted electrical communication between the foot end backup battery 202B and the foot end actuator input 212B. For the head end user input device 204A, the drive state is defined by electrical communication between the head end backup battery 202A and head end actuator input 212A. Similarly, for the foot end user input device 204B, the drive state is defined by electrical communication between the foot end backup battery 202B and foot end actuator input 212B. It should be appreciated that the head end user input device 204A and the foot end user input device 204B may independently switch between the interrupt mode and the drive mode.

Similar to as discussed above, in other configurations, such as shown in FIGS. 9 and 10A-10B, the backup user input device 204 may be also configured for user-selected operation between an interrupt state and a drive state. In the configurations shown in FIGS. 9 and 10A-10B, the interrupt state is defined by interrupted electrical communication between the battery 160 and the lift assembly input 190. Also, in the configurations shown in FIGS. 9 and 10A-10B, the drive state is defined by electrical communication between the battery 160 and the lift assembly input 190.

In the drive state, the backup user input device(s) 204, 204A, 204B are configured to provide power from the backup battery/batteries 202, 202A, 202B or reserve power from the battery 160 (for the configurations shown in FIGS. 9-10B) to power the one or more actuators 148 of the lift assembly 146 to move the one or more actuators 148 in the first direction and/or the second direction to raise or lower the intermediate frame 106 relative to the base 104 in response to user engagement with the backup user input device 204. Accordingly, the backup user input device 204 enables the lift assembly 146 to be operated during operation of the patient transport apparatus controller 158 in the suspended mode, allowing a user to operate the lift assembly 146 in emergency situations where the functionality of the patient transport apparatus 100 would otherwise be inhibited due to the state of charge of the battery 160 being below the predetermined threshold.

In some configurations, the backup user input device 204 is configured to operate the one or more actuators 148 of the lift assembly 146 simultaneously and in one direction. For example, based on user engagement with the backup user input device 204, the backup user input device may provide power to the head end actuator 150 and the foot end actuator 152 to simultaneously move both the head end actuator 150 and the foot end actuator 152 in the same direction, such as the second direction, to lower the lift assembly 146 in an emergency situation.

In some versions, the backup user input device 204 may include one or more backup input controls 216 arranged for user engagement to operate the lift assembly 146. For example, the backup user input device may include a singular backup input control 216 arranged for user engagement to operate the lift assembly 146. Upon user engagement of the singular backup input control 216, the backup user input device 204 may be configured to engage the drive mode to operate the one or more actuators 148 of the lift assembly 146 simultaneously in the second direction to lower the intermediate frame 106 relative to the base 104. In other configurations, the backup user input device 204 includes a pair of backup input controls 216, each arranged for user engagement to operate at least the lift assembly 146. In some configurations, the pair of backup input controls 216 acts as a redundancy, and the backup user input device 204 only operates the lift assembly 146 in response to simultaneous actuation of each of the backup input controls 216. In other words, in configurations where backup input controls are arranged as pairs, two-handed operation is required to operate the backup system 200 to operate the lift assembly 146. This arrangement helps to discourage routine caregiver use of the backup user input device 204 rather than the primary user input device 164 during normal operation (e.g., with a fully charged battery 160). Here too, it will be appreciated that “primary” and “backup” are non-limiting terms utilized herein to differentiate between two user input devices 164, 204, and other terms (e.g., “first” and “second”) could be used in place of the terms “primary” and “backup” in some versions.

In other configurations, the backup user input device 204 is configured to operate the one or more actuators 148 of the lift assembly 146 in both directions (either simultaneously or independently). Accordingly, the backup user input device 204 may include a switching circuit 214 to operate the backup user input device 204 between the interrupt state and a raise drive state or a lower drive state in response to user engagement with the backup user input device 204. The switching circuit 214 may be interposed between the backup user input device input 208 and the backup user input device output 210. As will be appreciated from the subsequent description below, in some versions, the switching circuit 214 may include or otherwise be defined by a single electrical component (e.g., a switch), or by a plurality of components (e.g., one or more switches, relays, circuits, controllers, discrete electrical components, and the like).

The switching circuit 214 may include, for example, a raise switch (not shown) and a lower switch (not shown). The raise switch may be operable between a raise switch interrupt state where the battery 160 (or, in the configuration of FIGS. 7 and 8, the backup battery/batteries 202, 202A, 202B) and the lift assembly input 190 are electrically decoupled, and a raise switch drive state where the battery 160 (or, in the configuration of FIGS. 7 and 8, the backup battery/batteries 202, 202A, 202B) and the lift assembly input 190 are electrically coupled to power the one or more actuators 148 of the lift assembly 146 to move in the first direction to raise the intermediate frame 106 relative to the base 104. The lower switch may be operable between a lower switch interrupt state where the battery 160 (or, in the configuration of FIGS. 7 and 8, the backup battery/batteries 202, 202A, 202B) and the lift assembly input 190 are electrically decoupled, and a lower switch drive state where the battery 160 (or, in the configuration of FIGS. 7 and 8, the backup battery/batteries 202, 202A, 202B) and the lift assembly input 190 are electrically coupled to power the one or more actuators 148 of the lift assembly 146 to move in the second direction to lower the intermediate frame 106 relative to the base 104.

The backup user input device 204 may also include a first backup input control 216A for operating the one or more actuators 148 in a first direction to raise the intermediate frame 106 relative to the base 104, and a second backup input control 216B for operating the one or more actuators 148 in a second direction to lower the intermediate frame 106 relative to the base 104. In some configurations, the first backup input control 216A is in electrical communication with the raise switch to operate the raise switch between the raise switch interrupt state and the raise switch drive state, and the second backup input control 216B is in electrical communication with the lower switch to operate the lower switch between the lower switch interrupt state and the lower switch drive state. Additional backup input controls 216 are contemplated. For example, the backup user input device 204 may include additional backup input controls 166 arranged for user engagement to facilitate independent operation of the head end actuator 150 and the foot end actuator 152. Other configurations are contemplated.

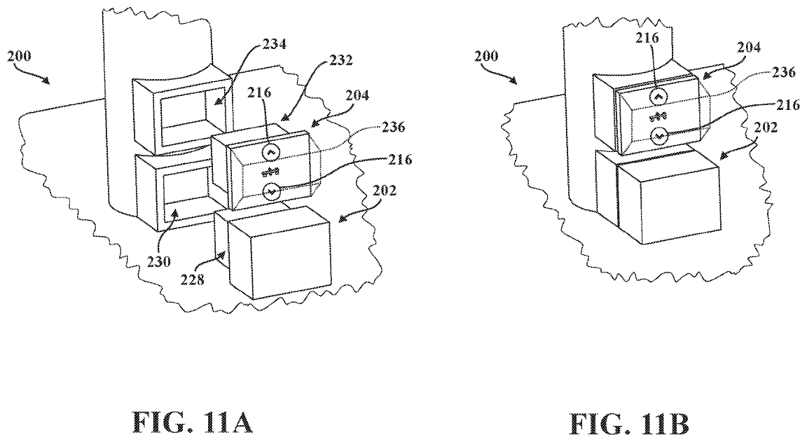

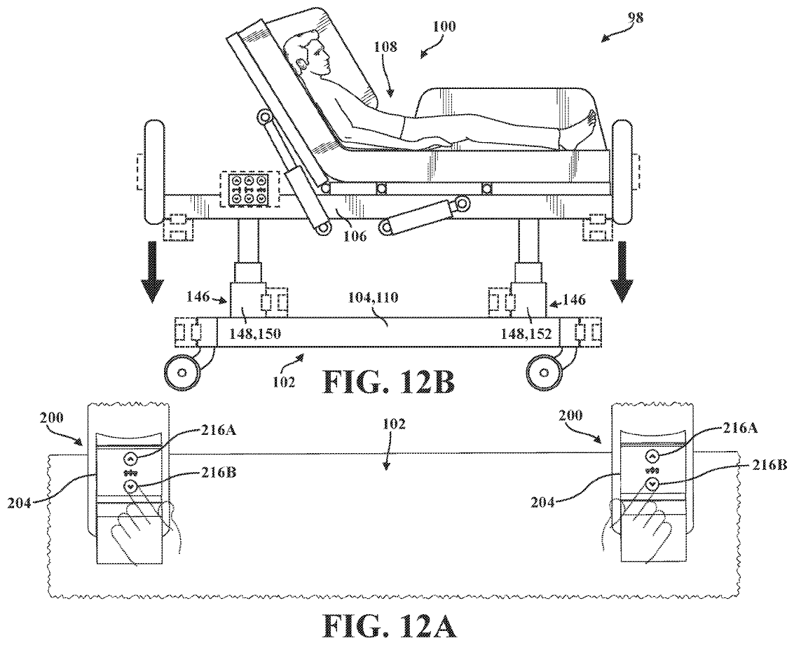

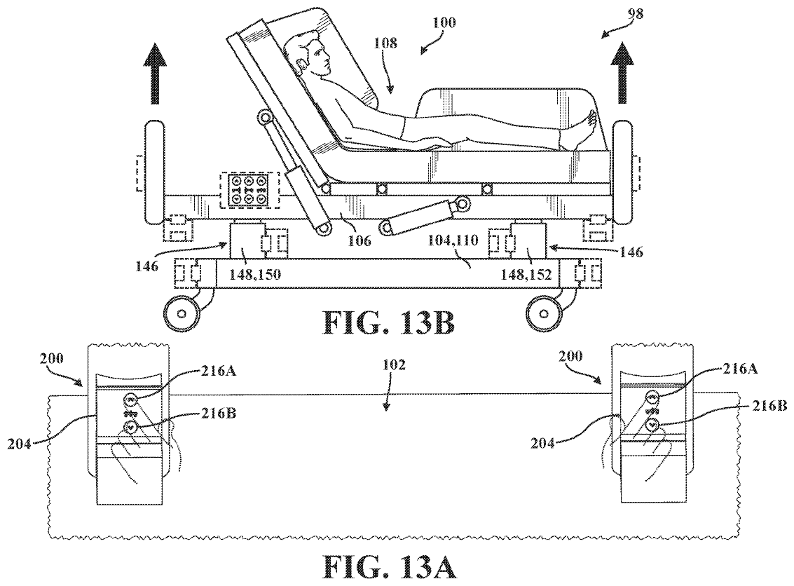

Referring to FIGS. 11A-13B, in some versions, the backup user input device 204 includes a pair of first backup input controls 216A and a pair of second backup input controls 216B, each arranged for user engagement to operate at least the lift assembly 146. In the illustrated configuration, the pair of backup input controls 216A, 216B acts as a redundancy, and the backup user input device 204 only operates the lift assembly 146 in response to simultaneous actuation of each corresponding pair of backup input controls 216A, 216B. As also illustrated by FIGS. 11A-11B, 12A, and 13A, in some configurations, each pair of backup input controls 216A. 216B may be disposed in spaced relation from each other in various ways so as to inhibit single-handed operation by the caregiver.

Referring to FIG. 9, in some versions, the backup user input device output 210 is in electrical communication with the lift assembly input 190 to provide power from the battery 160 to the lift assembly 146 in response to user engagement with the backup user input device 204. However, in other configurations, such as shown in FIGS. 10A-10B, the backup user input device may be in electrical communication with the motion control circuit 174.

Referring to FIGS. 10A-10B, to facilitate the connection of the backup user input device 204 to the motion control circuit 174, in some configurations, the motion control circuit 174 of the patient transport apparatus controller 158 further includes a bridge switch 218. The bridge switch 218 may be interposed between the motion control unit 176 and the motor bridge 182. More specifically, in some configurations, the bridge switch 218 is interposed between the motion control unit output 180 and the motor bridge input 184. The bridge switch 218 may be operable between an open bridge state (shown in FIG. 10B) to interrupt electrical communication between the motor bridge 182 and the motion control unit 176, and a closed bridge state (shown in FIG. 10A) to electrically couple the motor bridge 182 to the motion control unit 176. The patient transport apparatus controller 158 is configured to operate the bridge switch 218 in the closed bridge state in response to charge in the battery 160 being above a predetermined bridge switch threshold. In other words, when the charge in the battery 160 is below the predetermined bridge switch threshold, the patient transport apparatus controller 158 is configured to operate the bridge switch 218 in the open bridge state to electrically decouple the motion control unit 176 from the motor bridge 182 to allow the backup system 200 to power and operate the lift assembly 146. In some configurations, the switch threshold may be the same as the predetermined threshold of the state of charge of the battery 160, however, different thresholds are contemplated.

With continued reference to FIGS. 10A-10B, in the illustrated configuration, the patient transport apparatus controller 158 further includes a bypass input 220 disposed in electrical communication with the backup user input device 204. A bypass circuit 222 is electrically coupled between the bypass input 220 and the lift assembly output 188 of the patient transport apparatus controller 158 to provide power to the lift assembly 146 from the backup system 200 during operation of the patient transport apparatus controller 158 in the suspended mode. Accordingly, in this configuration, power from the backup system 200 bypasses the motion control unit 176. The patient transport apparatus controller 158 may also include a switch circuit 224 electrically coupled between the bridge switch 218 and the motor bridge 182 (particularly, the motor bridge input 184). The patient transport apparatus controller 158 may also further include a diode 226 interposed between the bypass circuit 222 and the switch circuit 224 to inhibit electrical communication between the bypass circuit 222 and the switch circuit 224 when the bridge switch 218 operates in the closed bridge state.

In other words, when the bridge switch2 18 operates in the closed bridge state, the motion control unit 176 provides power from the battery 160 to the motor bridge 182 based on user engagement with the primary user input device 164, and the diode acts to prevent electrical backflow from the switch circuit 224 into the bypass circuit 222. Conversely, when the bridge switch2 18 operates in the open bridge state, the bypass circuit 222 provides power from the backup system 200 to power and operate the lift assembly 146 based on user engagement with the backup user input device 204.

In some configurations, the backup battery 202 and/or the backup user input device 204 may be removable coupled to the support structure 102. In some configurations, the backup battery 202 and/or the backup user input device 204 are coupled to the base 104, but they may be couple elsewhere suitable on the support structure 102 such as, but not limited to, the intermediate frame 106. Referring back to FIGS. 11A-13B, the backup battery 202 may define a backup battery coupler 228 (i.e., an interface defined by the backup battery 202) for removably coupling the backup battery 202 to the support structure 102. Accordingly, the support structure 102 may define a corresponding backup battery receiver 230 shaped to receive the backup battery coupler 228 to couple the backup battery 202 physically and electrically to the patient transport system 98 (particularly, the backup system 200). Accordingly, FIG. 11A shows the backup battery 202 spaced from the backup battery receiver 230, and FIG. 11B should the backup battery coupler 228 engaged with the backup battery receiver 230. In some configurations, the backup battery receiver 230 may be defined by the base 104.

Similarly, in some configurations, referring back to FIGS. 11A-13B, the backup user input device 204 may define a backup user input device coupler 232 (i.e., an interface defined by the backup user input device 204) for removably coupling the backup user input device 204 to the support structure 102. Accordingly, the support structure 102 may defines a backup user interface receiver 234 shaped to receive the backup user input device coupler 232 to couple the backup user input device 204 physically and electrically to the patient transport system 98 (particularly, the backup system 200). Here, FIG. 11A shows the backup user input device 204 spaced from the backup user input device receiver 234, and FIG. 11B shows the backup user input device coupler 232 engaged with the backup user input device receiver 234. In some configurations, the backup user input device receiver 234 may be defined by the base 104. Additionally, as illustrated in phantom in FIGS. 11A and 11B, the backup user input device 204 may include a backup user input device cover 236 operatively attached to the backup user input device 204 to prevent inadvertent engagement of the backup input control(s) 216. In some configurations, the backup user input device cover 236 may be pivotably attached to the backup user input device 204 such that a user may pivot the backup user input device cover 236 to access the backup user input device 204 to operate the backup system 200. In other configurations, such as shown schematically in FIGS. 1-4, the backup battery and the backup user input device 204 may be one integral unit that is removable coupled to the support structure 102.

Several examples have been discussed in the foregoing description. However, the examples discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

The present disclosure also comprises the following clauses, with specific features laid out in dependent clauses, that may specifically be implemented as described in greater detail with reference to the configurations and drawings above.

### Clauses

I. A patient transport system for supporting a patient, the patient transport system comprising:
a patient transport apparatus including:
   a support structure including a base, an intermediate frame having a patient support deck, and a lift assembly arranged between the base and the intermediate frame and including an electric actuator configured to raise and lower the intermediate frame relative to the base,
   a primary battery for providing power to the patient transport apparatus,
   a primary user input device coupled to the support structure and arranged for user engagement to operate the lift assembly, and
   a patient transport apparatus controller disposed in electrical communication with the lift assembly, the primary battery, and the primary user input device, the patient transport apparatus controller being operable between: a suspended mode, and an operating mode to drive the electric actuator of the lift assembly with power from the primary battery in response to user engagement with the primary user input device when a charge state of the primary battery is above a predetermined charge threshold; and
a backup system for operating the lift assembly during operation of the patient transport apparatus controller in the suspended mode, the backup system including:
   a backup battery operatively attached to the support structure for providing power to the electric actuator, and
   a backup user input device in electrical communication with the backup battery and the electric actuator, the backup user input device arranged for user engagement to operate the lift assembly during operation of the patient transport apparatus controller in the suspended mode.

II. The patient transport apparatus of clause I, wherein:
the backup battery includes a backup battery coupler;
the support structure defines a backup battery receiver shaped to receive the backup battery coupler; and
the backup battery coupler is removably disposed in the backup battery receiver to operatively attach the backup battery to the support structure.

III. The patient transport apparatus of clause II, wherein the backup battery receiver is defined by the base.

IV. The patient transport apparatus of any of clauses I-III, wherein the backup user input device is coupled to the base.

V. The patient transport apparatus of any of clauses I-IV, wherein:
the backup user input device includes a backup user input device coupler;
the support structure defines a backup user input device receiver shaped to receive the backup user input device coupler; and
the backup user input device coupler is removably disposed in the backup user input device receiver to operatively attach the backup user input device to the support structure.

VI. The patient transport apparatus of clause V, wherein the backup user input device receiver is defined by the base.

VII. The patient transport system of any of clauses I-VI, wherein the patient transport apparatus controller defines a lift assembly output disposed in electrical communication with a lift assembly input defined by the lift assembly to provide power to the electric actuator; and
wherein the backup system is disposed in electrical communication with the lift assembly input

VIII. The patient transport system of clause VII, wherein the backup user input device is interposed between the backup battery and the lift assembly input, with the backup user input device being configured for user-selected operation between:
an interrupt state defined by interrupted electrical communication between the backup battery and the lift assembly input, and
a drive state defined by electrical communication between the backup battery and the lift assembly input.

IX. The patient transport system of clause VIII, wherein the electric actuator is operable in a first direction to raise the intermediate frame relative to the base, and in a second direction to lower the intermediate frame relative to the base; and
wherein the electric actuator moves in the second direction in response to user engagement with the backup user input device in the drive state to lower the intermediate frame relative to the base.

X. The patient transport apparatus of clause IX, wherein the backup user input device includes a pair of backup input controls, each of the pair of backup input controls arranged for user engagement to operate at least the lift assembly.

XI. The patient transport apparatus of clause X, wherein the backup user input device operates the lift assembly in response to simultaneous actuation of each of the pair of backup input controls.

XII. The patient transport apparatus of clause XI, wherein each backup input control is disposed in spaced relation from each other to inhibit single-handed operation by a user.

XIII. The patient transport apparatus of any of clauses VIII-XII, wherein the backup user input device includes a switching circuit to operate the backup user input device between the interrupt state and the drive state in response to user engagement with the backup user input device.

XIV. The patient transport system of clause XIII, wherein the backup user input device includes:
a first backup input control for operating the electric actuator in a first direction to raise the intermediate frame relative to the base, and
a second backup input control for operating the electric actuator in a second direction to lower the intermediate frame relative to the base.

XV. The patient transport apparatus of any of clauses XIII-XIV, wherein the switching circuit includes:
a raise switch operable between:
   a raise switch interrupt state where the backup battery and the lift assembly input are electrically decoupled, and
   a raise switch drive state where the backup battery and the lift assembly input are electrically coupled to power the electric actuator to raise the intermediate frame relative to the base; and
a lower switch operable between:
   a lower switch interrupt state where the backup battery and the lift assembly input are electrically decoupled, and
   a lower switch drive state where the backup battery and the lift assembly input are electrically coupled to power the electric actuator to lower the intermediate frame relative to the base.

XVI. The patient transport system of clause XV, wherein the backup user input device includes:
a first backup input control for operating the electric actuator in a first direction to raise the intermediate frame relative to the base, and
a second backup input control for operating the electric actuator in a second direction to lower the intermediate frame relative to the base.

XVII. The patient transport system of clause XVI, wherein:
the first backup input control is in electrical communication with the raise switch to operate the raise switch between the raise switch interrupt state and the raise switch drive state; and
the second backup input control is in electrical communication with the lower switch to operate the lower switch between the lower switch interrupt state and the lower switch drive state.

XVIII. The patient transport system of any of clauses XVI-XVII, wherein the support structure defines a head end and a foot end;
wherein the electric actuator is further defined as a foot end actuator arranged to raise and lower the intermediate frame relative to the base adjacent to the foot end; and
wherein the lift assembly further includes a head end actuator arranged to raise and lower the intermediate frame relative to the base adjacent to the head end.

XIX. The patient transport system of clause XVIII, wherein the foot end actuator further includes a foot end actuator input defined by the foot end actuator to provide power to the foot end actuator;
wherein the head end actuator further includes a head end actuator input defined by the head end actuator to provide power to the head end actuator; and
wherein the foot end actuator input and the head end actuator input define the lift assembly input.

XX. The patient transport system of clause XIX, wherein the backup system is disposed in electrical communication with the foot end actuator input and the head end actuator input for simultaneously operating the head end actuator and the foot end actuator in response to user engagement with the backup user input device.

XXI. The patient transport system of any of clauses XIX-XX, wherein the backup system is further defined as a foot end backup system including a foot end backup battery and a foot end backup user input device, with the foot end backup system disposed in electrical communication with the foot end actuator input for operating the foot end actuator with power from the foot end backup battery in response to user engagement with the foot end backup user input device; and
further comprising a head end backup system including a head end backup battery and a head end backup user input device, with the head end backup system disposed in electrical communication with the head end actuator input for operating the head end actuator with power from the head end backup battery in response to user engagement with the head end backup user input device.

XXII. The patient transport system of any of clauses I-XXI, wherein the support structure defines a head end and a foot end;
wherein the electric actuator is further defined as a foot end actuator arranged to raise and lower the intermediate frame relative to the base adjacent to the foot end;
wherein the lift assembly further includes a head end actuator arranged to raise and lower the intermediate frame relative to the base adjacent to the head end;
wherein the backup system is further defined as a foot end backup system including a foot end backup battery and a foot end backup user input device, with the foot end backup system disposed in electrical communication with the foot end actuator for operating the foot end actuator with power from the foot end backup battery in response to user engagement with the foot end backup user input device; and
further comprising a head end backup system including a head end backup battery and a head end backup user input device, with the head end backup system disposed in electrical communication with the head end actuator for operating the head end actuator with power from the head end backup battery in response to user engagement with the head end backup user input device.

XXIII. The patient transport apparatus of any of clauses I-XXII, wherein the primary user input device is coupled to the intermediate frame for concurrent movement relative to the base.

XXIV. The patient transport apparatus of clause XXIII, wherein the primary user input device includes a primary input control arranged for user engagement to operate the lift assembly.

XXV. The patient transport apparatus of any of clauses I-XXIV, wherein the backup battery is configured to be charged by at least one of the primary battery or an AC mains power supply.

XXVI. The patient transport apparatus of any of clauses I-XXV, wherein the backup system further includes an alarm configured to generate an alert when a state of charge of the backup battery is below an operable threshold.

XXVII. The patient transport apparatus of any of clauses I-XXVI, wherein the backup system further includes a visual indicator configured to provide visual indication when a state of charge of the backup battery is below an operable threshold.

XXVIII. A patient transport apparatus for supporting a patient, the patient transport apparatus comprising:
a support structure including a base, an intermediate frame having a patient support deck, and a lift assembly arranged between the base and the intermediate frame and including an electric actuator configured to raise and lower the intermediate frame relative to the base;
a battery for providing power to the patient transport apparatus;
a primary user input device coupled to the support structure and arranged for user engagement to operate the lift assembly;
a patient transport apparatus controller disposed in electrical communication with the lift assembly, the battery, and the primary user input device, the patient transport apparatus controller configured to operate the lift assembly between a suspended mode and an operating mode to drive the electric actuator of the lift assembly with power from the battery in response to user engagement with the primary user input device when a charge state of the battery is above a predetermined charge threshold; and
a backup system for operating the lift assembly during operation of the patient transport apparatus in the suspended mode, the backup system including a backup user input device coupled to the support structure and in electrical communication with the battery and the electric actuator, the backup user input device arranged for user engagement to operate the lift assembly when the patient transport apparatus controller is in the suspended mode.

XXIX. The patient transport apparatus of clause XXVIII, wherein the patient transport apparatus controller includes a motion control circuit interposed between the battery and the lift assembly, the motion control circuit configured to operate the lift assembly.

XXX. The patient transport apparatus of clause XXIX, wherein the motion control circuit includes:
a lift assembly output disposed in electrical communication with a lift assembly input defined by the lift assembly to provide power to the electric actuator;
a motor bridge electrically coupled to the lift assembly output; and
a motion control unit electrically coupled to the motor bridge to drive the electric actuator with power from the battery in response to user engagement with the primary user input device.

XXXI. The patient transport apparatus of clause XXX, wherein the backup user input device is interposed between the battery and the lift assembly input, with the backup user input device being configured for user-selected operation between:
an interrupt state defined by interrupted electrical communication between the battery and the lift assembly input, and
a drive state defined by electrical communication between the battery and the lift assembly input.

XXXII. The patient transport apparatus of clause XXXI, wherein the backup user input device includes a switching circuit to operate the backup user input device between the interrupt state and the drive state in response to user engagement with the backup user input device.

XXXIII. The patient transport apparatus of clause XXXII, wherein the switching circuit includes:
a raise switch operable between:
   a raise switch interrupt state where the battery and the lift assembly input are electrically decoupled, and
   a raise switch drive state where the battery and the lift assembly input are electrically coupled to power the electric actuator to raise the intermediate frame relative to the base; and
a lower switch operable between:
   a lower switch interrupt state where the battery and the lift assembly input are electrically decoupled, and
   a lower switch drive state where the battery and the lift assembly input are electrically coupled to power the electric actuator to lower the intermediate frame relative to the base.

XXXIV. The patient transport apparatus of clause XXXIII, wherein the backup user input device includes:
a first backup input control for operating the electric actuator in a first direction to raise the intermediate frame relative to the base, and
a second backup input control for operating the electric actuator in a second direction to lower the intermediate frame relative to the base.

XXXV. The patient transport apparatus of clause XXXIV, wherein:
the first backup input control is in electrical communication with the raise switch to operate the raise switch between the raise switch interrupt state and the raise switch drive state; and
the second backup input control is in electrical communication with the lower switch to operate the lower switch between the lower switch interrupt state and the lower switch drive state.

XXXVI. The patient transport apparatus of clause XXXV, wherein the support structure defines a head end and a foot end;
wherein the electric actuator is further defined as a foot end actuator arranged to raise and lower the intermediate frame relative to the base adjacent to the foot end; and
wherein the lift assembly further includes a head end actuator arranged to raise and lower the intermediate frame relative to the base adjacent to the head end.

XXXVII. The patient transport apparatus of clause XXXVI, wherein the lift assembly output of the patient transport apparatus controller is further defined as a foot end lift assembly output disposed in electrical communication with a foot end actuator input defined by the foot end actuator to provide power to the foot end actuator; and
wherein the patient transport apparatus controller further defines a head end lift assembly output disposed in electrical communication with a head end actuator input defined by the head end actuator to provide power to the head end actuator.

XXXVIII. The patient transport apparatus of clause XXXVII, wherein the backup system is disposed in electrical communication with the foot end actuator input and the head end actuator input for simultaneously operating the head end actuator and the foot end actuator in response to user engagement with the backup user input device.

XXXIX. The patient transport apparatus of any of clauses XXXVII-XXXVIII, wherein the backup system is disposed in electrical communication with the foot end actuator input and the head end actuator input for operating at least one of the head end actuator and the foot end actuator in response to user engagement with the backup user input device.

XL. The patient transport apparatus of any of clauses XXXI-XXXIX, wherein the patient transport apparatus controller further includes a bridge switch interposed between the motor bridge and the motion control unit, with the bridge switch being operable between:
an open bridge state to interrupt electrical communication between the motor bridge and the motion control unit, and
a closed bridge state to electrically couple the motor bridge to the motion control unit.

XLI. The patient transport apparatus of clause XL, wherein the patient transport apparatus controller is configured to operate the bridge switch in the closed bridge state in response to charge in the battery being above a predetermined bridge switch threshold.

XLII. The patient transport apparatus of any of clauses XL-XLI, wherein the patient transport apparatus controller includes:
a bypass input disposed in electrical communication with the backup user input device;
a bypass circuit electrically coupled between the bypass input and the lift assembly output;
a switch circuit electrically coupled between the bridge switch and the motor bridge; and
a diode interposed between the bypass circuit and the switch circuit to inhibit electrical communication between the bypass circuit and the switch circuit when the bridge switch operates in the closed bridge state.

XLIII. The patient transport apparatus of any of clauses XXVIII-XLII, wherein the backup user input device is interposed between the battery and the lift assembly, with the backup user input device being configured for user-selected operation between:
an interrupt state defined by interrupted electrical communication between the battery and the lift assembly, and
a drive state defined by electrical communication between the battery and the lift assembly.

XLIV. The patient transport apparatus of any of clauses XXVIII-XLIII, wherein the predetermined charge threshold is defined as a state of charge to permit a predetermined number of articulations of the electric actuator reserved for emergency situations.

XLV. The patient transport apparatus of any of clauses XXVIII-XLIV, wherein the primary user input device is disposed on the intermediate frame.

XLVI. The patient transport apparatus of clause XLV, wherein the primary user input device includes a primary input control arranged for user engagement to operate the lift assembly.

XLVII. The patient transport apparatus of any of clauses XXVIII-XLVI, wherein the backup user input device is disposed on the base.

XLVIII. The patient transport apparatus of any of clauses XXVIII-XL VII, wherein the backup user input device includes a pair of backup input controls, each of the pair of backup input controls arranged for user engagement to operate at least the lift assembly.

XLIX. The patient transport apparatus of clause XLVIII, wherein the backup user input device operates the lift assembly in response to simultaneous actuation of each of the pair of backup input controls.

L. The patient transport apparatus of clause XLIX, wherein each backup input control is disposed in spaced relation from each other to inhibit single-handed operation by a user.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A patient transport apparatus for supporting a patient, the patient transport apparatus comprising:
a support structure including a base, an intermediate frame having a patient support deck, and a lift assembly arranged between the base and the intermediate frame and including an electric actuator configured to raise and lower the intermediate frame relative to the base;
a battery for providing power to the patient transport apparatus;
a primary user input device coupled to the support structure and arranged for user engagement to operate the lift assembly;
a patient transport apparatus controller disposed in electrical communication with the lift assembly, the battery, and the primary user input device, the patient transport apparatus controller configured to operate the lift assembly between a suspended mode and an operating mode to drive the electric actuator of the lift assembly with power from the battery in response to user engagement with the primary user input device when a charge state of the battery is above a predetermined charge threshold; and
a backup system for operating the lift assembly during operation of the patient transport apparatus in the suspended mode, the backup system including a backup user input device coupled to the support structure and in electrical communication with the battery and the electric actuator, the backup user input device arranged for user engagement to operate the lift assembly when the patient transport apparatus controller is in the suspended mode.

29. The patient transport apparatus of claim 28, wherein the patient transport apparatus controller includes a motion control circuit interposed between the battery and the lift assembly, the motion control circuit configured to operate the lift assembly.

30. The patient transport apparatus of claim 29, wherein the motion control circuit includes:
a lift assembly output disposed in electrical communication with a lift assembly input defined by the lift assembly to provide power to the electric actuator;
a motor bridge electrically coupled to the lift assembly output; and
a motion control unit electrically coupled to the motor bridge to drive the electric actuator with power from the battery in response to user engagement with the primary user input device.

31. The patient transport apparatus of claim 30, wherein the backup user input device is interposed between the battery and the lift assembly input, with the backup user input device being configured for user-selected operation between:
an interrupt state defined by interrupted electrical communication between the battery and the lift assembly input, and
a drive state defined by electrical communication between the battery and the lift assembly input.

32. The patient transport apparatus of claim 31, wherein the backup user input device includes a switching circuit to operate the backup user input device between the interrupt state and the drive state in response to user engagement with the backup user input device.

33. The patient transport apparatus of claim 32, wherein the switching circuit includes:
a raise switch operable between:
a raise switch interrupt state where the battery and the lift assembly input are electrically decoupled, and
a raise switch drive state where the battery and the lift assembly input are electrically coupled to power the electric actuator to raise the intermediate frame relative to the base; and
a lower switch operable between:
a lower switch interrupt state where the battery and the lift assembly input are electrically decoupled, and
a lower switch drive state where the battery and the lift assembly input are electrically coupled to power the electric actuator to lower the intermediate frame relative to the base.

34. The patient transport apparatus of claim 33, wherein the backup user input device includes:
a first backup input control for operating the electric actuator in a first direction to raise the intermediate frame relative to the base, and
a second backup input control for operating the electric actuator in a second direction to lower the intermediate frame relative to the base.

35. The patient transport apparatus of claim 34, wherein:
the first backup input control is in electrical communication with the raise switch to operate the raise switch between the raise switch interrupt state and the raise switch drive state; and
the second backup input control is in electrical communication with the lower switch to operate the lower switch between the lower switch interrupt state and the lower switch drive state.

36. The patient transport apparatus of claim 35, wherein the support structure defines a head end and a foot end;
wherein the electric actuator is further defined as a foot end actuator arranged to raise and lower the intermediate frame relative to the base adjacent to the foot end; and
wherein the lift assembly further includes a head end actuator arranged to raise and lower the intermediate frame relative to the base adjacent to the head end.

37. The patient transport apparatus of claim 36, wherein the lift assembly output of the patient transport apparatus controller is further defined as a foot end lift assembly output disposed in electrical communication with a foot end actuator input defined by the foot end actuator to provide power to the foot end actuator; and
wherein the patient transport apparatus controller further defines a head end lift assembly output disposed in electrical communication with a head end actuator input defined by the head end actuator to provide power to the head end actuator.

38. The patient transport apparatus of claim 37, wherein the backup system is disposed in electrical communication with the foot end actuator input and the head end actuator input for simultaneously operating the head end actuator and the foot end actuator in response to user engagement with the backup user input device.

39. The patient transport apparatus of claim 37, wherein the backup system is disposed in electrical communication with the foot end actuator input and the head end actuator input for operating at least one of the head end actuator and the foot end actuator in response to user engagement with the backup user input device.

40. The patient transport apparatus of claim 31, wherein the patient transport apparatus controller further includes a bridge switch interposed between the motor bridge and the motion control unit, with the bridge switch being operable between:
an open bridge state to interrupt electrical communication between the motor bridge and the motion control unit, and
a closed bridge state to electrically couple the motor bridge to the motion control unit.

41. The patient transport apparatus of claim 40, wherein the patient transport apparatus controller is configured to operate the bridge switch in the closed bridge state in response to charge in the battery being above a predetermined bridge switch threshold.

42. The patient transport apparatus of claim 40, wherein the patient transport apparatus controller includes:
a bypass input disposed in electrical communication with the backup user input device;
a bypass circuit electrically coupled between the bypass input and the lift assembly output;
a switch circuit electrically coupled between the bridge switch and the motor bridge; and
a diode interposed between the bypass circuit and the switch circuit to inhibit electrical communication between the bypass circuit and the switch circuit when the bridge switch operates in the closed bridge state.

43. The patient transport apparatus of claim 28, wherein the backup user input device is interposed between the battery and the lift assembly, with the backup user input device being configured for user-selected operation between:
an interrupt state defined by interrupted electrical communication between the battery and the lift assembly, and
a drive state defined by electrical communication between the battery and the lift assembly.

44. The patient transport apparatus of claim 28, wherein the predetermined charge threshold is defined as a state of charge to permit a predetermined number of articulations of the electric actuator reserved for emergency situations.

45. The patient transport apparatus of claim 28, wherein the primary user input device is disposed on the intermediate frame; and
wherein the primary user input device includes a primary input control arranged for user engagement to operate the lift assembly.

46. (canceled)

47. The patient transport apparatus of claim 28, wherein the backup user input device is disposed on the base.

48. The patient transport apparatus of claim 28, wherein the backup user input device includes a pair of backup input controls, each of the pair of backup input controls arranged for user engagement to operate at least the lift assembly;
wherein the backup user input device operates the lift assembly in response to simultaneous actuation of each of the pair of backup input controls; and
wherein the backup input control are disposed in spaced relation from each other to inhibit single-handed operation by a user.

49. (canceled)

50. (canceled)
